(19) United States
(12) Patent Application Publication
(10) Pub. No.: US 2018/0252100 A1
(43) Pub. Date: Sep. 6, 2018

(54) SUBSURFACE ELECTRIC FIELD MONITORING METHODS AND SYSTEMS EMPLOYING A CURRENT FOCUSING CEMENT ARRANGEMENT

(71) Applicant: Halliburton Energy Services, Inc., Houston, TX (US)

(72) Inventors: Priyesh Ranjan, Houston, TX (US); Ahmed Elsayed Fouda, Houston, TX (US); Burkay Donderici, Pittsford, NY (US); Mikko Jaaskelainen, Katy, TX (US)

(21) Appl. No.: 15/759,299

(22) PCT Filed: Dec. 11, 2015
(86) PCT No.: PCT/US2015/065340

§ 371 Date: Mar. 12, 2018

(51) Int. Cl. E21B 49/00; E21B 33/12; E21B 33/14; E21B 17/10; E21B 47/10; E21B 47/01; G01V 3/26; G01V 3/38

(52) U.S. Cl. CPC E21B 49/00; E21B 33/12; E21B 33/14; G01V 3/38; E21B 47/102; E21B 47/011; G01V 3/26; E21B 17/1078

(57) ABSTRACT

A subsurface electric field monitoring system includes one or more electric field sensors deployed external to a casing in a borehole formed in a downhole formation. The system also includes a multi-layer cement arrangement external to the casing, where the multi-layer cement arrangement focuses emitted current to a target region of the downhole formation. The system also includes a data processing system that receives measurements collected by the one or more electric field sensors in response to the focused emitted current, wherein the data processing system models the subsurface electric field based on the received measurements.

### BACKGROUND

Oil field operators drill boreholes into subsurface reservoirs to recover oil and other hydrocarbons. If the reservoir has been partially drained or if the oil is particularly viscous, the oil field operators will often stimulate the reservoir, e.g., by injecting water or other fluids into the reservoir via secondary wells to encourage the oil to move to the primary (“production”) wells and thence to the surface. Other stimulation treatments include fracturing (creating fractures in the subsurface formation to promote fluid flow) and acidizing (enlarging pores in the formation to promote fluid flow).

The stimulation processes can be tailored with varying fluid mixtures, flow rates/pressures, and injection sites, but may nevertheless be difficult to control due to inhomogeneity in the structure of the subsurface formations. The production process for the desired hydrocarbons also has various parameters that can be tailored to maximize well profitability or some other measure of efficiency. Without sufficiently detailed information regarding the effects of stimulation processes on a given reservoir and the availability and source of fluid flows for particular production zones, the operator is sure to miss many opportunities for increased hydrocarbon recovery.

### BRIEF DESCRIPTION OF THE DRAWINGS

Accordingly, there are disclosed herein subsurface electric field monitoring methods and systems employing a current focusing cement arrangement. In the drawings:

FIG. 1 is a diagram showing an illustrative environment for subsurface electric field monitoring.

FIGS. 2A-2C are diagrams showing components of an illustrative first subsurface electric field monitoring system configuration.

FIGS. 3A and 3B are diagrams showing components of an illustrative second subsurface electric field monitoring system configuration.

FIGS. 4A and 4B are diagrams showing components of an illustrative third subsurface electric field monitoring system configuration.

FIGS. 5A and 5B are diagrams showing components of an illustrative fourth subsurface electric field monitoring system configuration.

FIG. 6 is a diagram showing another electric field sensing option.

FIGS. 7A-7C are diagrams showing illustrative multiplexing architectures for distributed electric field sensing.

FIG. 8 is a signal flow diagram for an illustrative formation monitoring method.

FIG. 9A is a graph showing illustrative signal levels for different cement resistivities.

FIG. 9B is a graph showing illustrative sensitivity for different cement resistivities.

FIG. 10 is a flowchart showing an illustrative subsurface electric field monitoring method involving a current focusing cement arrangement.

It should be understood, however, that the specific embodiments given in the drawings and detailed description below do not limit the disclosure. On the contrary, they provide the foundation for one of ordinary skill to discern the alternative forms, equivalents, and other modifications that are encompassed in the scope of the appended claims.

### DETAILED DESCRIPTION

Disclosed herein are subsurface electric field monitoring methods and systems employing a current focusing cement arrangement. The current focusing cement arrangement improves the range or accuracy of electric field monitoring for a target region of a downhole formation. As an example, the current focusing cement arrangement may include a conductive cement (low-resistivity or formation matching) section between two non-conductive cement (high-resistivity) sections, where electric field sensors used for electric field monitoring are covered by or embedded within the conductive section. In at least some embodiments, the electric field measurements obtained by the electric field sensors are azimuthally-sensitive measurements. For example, a plurality of electric field sensors that are azimuthally distributed around a casing may be used to collect azimuthally-sensitive electric field measurements. Further, one or more optical fibers may be employed to convey electric field measurements collected by the electric field sensors as optical signals to earth's surface. At earth's surface, the optical signals are converted back to electrical signals and are processed to model the subsurface electric field monitored by the electric field sensors. The monitored electric field can be used, for example, to track one or more waterfronts in a downhole formation. Waterfront position information obtained from electric field monitoring as described herein can be presented to a user via a computer display (e.g., by displaying coordinate positions or by visualization of any waterfront).

In at least some embodiments, an example subsurface electric field monitoring system includes one or more electric field sensors deployed external to a casing in a borehole formed in a downhole formation. The system also includes a multi-layer cement arrangement external to the casing, wherein the multi-layer cement arrangement focuses emitted current to a target portion of the downhole formation. The system also includes a data processing system that receives measurements collected by the one or more electric field sensors in response to the focused emitted current, wherein the data processing system models the subsurface electric field based on the received measurements.

Meanwhile, an example subsurface electric field monitoring method includes deploying one or more electric field sensors external to a casing in a borehole formed in a downhole formation. The method also includes focusing emitted current to a target region of the downhole formation using a multi-section cement arrangement external to the casing. The method also includes receiving measurements collected by the one or more electric field sensors in response to said focusing. The method also includes modeling the subsurface electric field based on the received measurements.

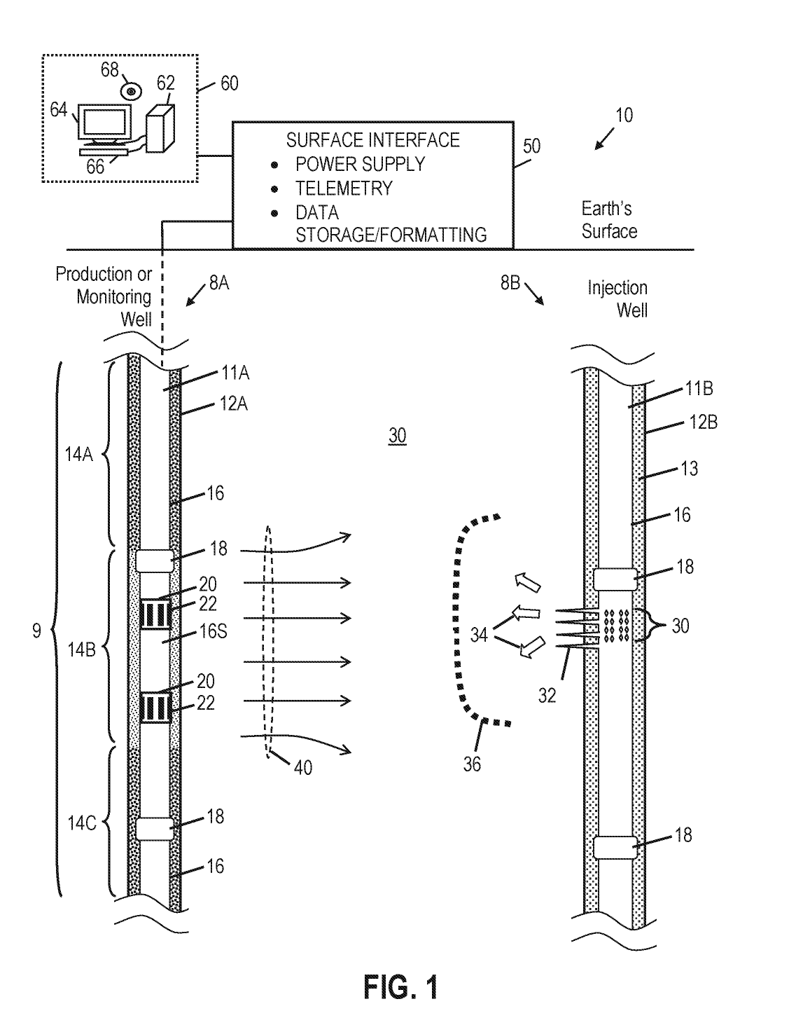

Turning now to the drawings, FIG. 1 shows an illustrative environment 10 for subsurface electric field monitoring. In environment 10, a production well or monitoring well 8A is represented as a borehole 12A with a casing string 11A having a plurality of casing segments 16 joined by collars 18. If the well 8A is a production well, the casing string 11A may include one or more sets of perforations, filters, and/or controllable flow zones (not shown). Further, a multi-section cement arrangement 9 is represented in FIG. 1, where the multi-section cement arrangement 9 includes a conductive cement section 14B between non-conductive cement sections 14A and 14C. With the multi-section cement arrangement 9, injected current is focused into the target region of the downhole formation 30 such that deeper reservoir monitoring is possible.

In at least some embodiments, the conductive cement section 14B may have the same order of magnitude resistivity as the surrounding target region of the downhole formation 30. As needed, the conductivity of the conductive cement section 14B can be increased by adding high conductivity additives, such as carbon, to the cement slurry used for conductive cement region 14B. It should be noted that the cement used for the conducting cement section 14B should not be too conductive to avoid shorting out the electric field sensors 22. In at least some embodiments, the conductivity of the conducting cement section 14B is matched with the target region of the downhole formation 30. Meanwhile, the non-conductive cement sections 14A and 14C have a higher resistivity. To increase resistivity of the non-conductive cement sections 14A and 14C, high resistivity additives may be mixed with the cement slurry used for the non-conductive cement regions 14A and 14C. Example high-resistivity additives include ceramic powder, epoxy resins, polyester resins and/or any other high resistivity material that can be mixed with cement without affect its integrity after curing. The non-conductive cement regions 14A and 14C act as insulators, restricting current leakage to the target region of the downhole formation 30.

In FIG. 1, a plurality of electric field sensors 22 are represented in the area of the conductive section 14B of the multi-section cement arrangement 9. For example, the electric field sensors 22 may be deployed along an exterior of a particular casing segment 16S of the casing string 11A. The position of the casing segment 16S is either known or is detectable to support cementing operations that result in the multi-section cement arrangement 9 being positioned relative to the casing segment 16S or the sensors 22 associated with the casing segment 16S. For example, measurements can be made during deployment of cement slurry downhole to determine when exactly pumping has to be stopped (so that conductive cement section 14B is at the area of investigation/sensors). In some embodiments, a gradual change in the cement conductivity is possible to avoid having a clear cut interface between the conducting cement section 14B and the non-conductive cement sections 14A and 14C.

In FIG. 1, the electric field sensors 22 are azimuthally distributed around an exterior of the casing segment 16S in two groups. Other sensor groupings or arrangements are possible, where fewer electric field sensors 22 or additional electric field sensors 22 are used. Further, it should be appreciated that azimuthal distribution of electric field sensors 22 is not a requirement. In at least some embodiments, the electric field sensors 22 correspond to electrodes that are insulated from the casing segment 16S. For example, at least five azimuthal measurements may be collected to uniquely determine the azimuthal direction of changes in formation resistivity. The electrodes corresponding to the electric field sensors 22 can be galvanic or capacitive. Capacitive electrodes have stable contact resistance and are less vulnerable to corrosion.

To perform electric field monitoring, a current source is needed. In at least some embodiments, the casing string 11A coupled to a surface power supply functions as the current source for electric field monitoring operations. For example, a power cable coupled to the surface interface 50 may connect to the casing string 11A at or near earth's surface (e.g., at a well head) or at the monitoring zone of interest (e.g., the zone represented by the conductive section 14B of the multi-section cement arrangement 9). In some embodiments, multiple power connections can be made if necessary. The return electrode can be placed in the formation sufficiently far away from the casing string 11A (i.e., a monopole configuration), or can be connected to the casing string 11A far away from the injection electrode (i.e., a bipole configuration).

In FIG. 1, the electric field lines 40 in the downhole formation 30 are due to current being emitted by the casing string 11A (e.g., the current supplied by the surface interface 50) and focused by the multi-section cement arrangement 9. For embodiments, where the casing string 11A operates as a current source, the electric field sensors 22 may be insulated from the casing string 11A. For example, insulating pads 20 may be used to electrically insulate the electric field sensors 22 from the casing segment 16S. In other embodiments, the electric field sensors 22 may be mounted to insulating centralizers or insulating swellable packers. Further, in some embodiments, a current source may be positioned downhole at a target depth to inject current into the downhole formation 30 without using the casing string 11A. Regardless of the current source being used, the multi-section cement arrangement 9 focuses the current to a target region of the downhole formation 30.

During electric field monitoring, the injection well 8B may be injecting water into the downhole formation 30 to direct hydrocarbons towards well 8A. The injection well 8B is represented as a borehole 12B with a casing string 11B having a plurality of casing segments 16 joined by collars 18. Cement 13 may fill the space between the casing string 11B and the wall of the borehole 12B. Along the casing string 11B, one or more sets of perforations 30 and 32 enable water 34 to leave the casing string 11B and enter the downhole formation 30, resulting in a waterfront 36 that moves towards the well 8A over time.

To monitor the waterfront 36, the current focusing cement arrangement 9 focuses current emitted by the casing string 11A and/or another current source into the downhole formation 30. Electric field measurements in response to the focused current are collected by the electric field sensors 22. The collected electric field measurements are conveyed to earth's surface for analysis. In some embodiments, electrical circuitry (e.g., signal amplifiers) and conductors may be used to convey collected electric field measurements. In such case, a remote power supply and/or other electronics is needed. Alternatively, collected electric field measurements may be converted to optical signals that are conveyed to earth's surface. With optical conveyance of the collected measurements, remote power supplies can be omitted resulting in a more permanent electric field monitoring installation downhole. At earth's surface, the collected electric field measurement are received by the surface interface 50. As needed, the surface interface 50 may store, decode, format and/or process the collected electric field measurements. The raw signals or processed signals corresponding to the collected electric field measurements may be provided from the surface interface 50 to a computer system 60 for analysis. For example, the computer system 60 may process the collected electric field measurements to model the subsurface electric field monitored by the electric field sensors 22. The monitored electric field can be used, for example, to track position of the waterfront 36. The position of the waterfront 36 can be presented to a user via a computer system 60 (e.g., by displaying coordinate positions or by visualization of any waterfront). In different scenarios, the computer system 60 may direct electric field monitoring operations and/or receive measurements from the electric field sensors 22. The computer system 60 may also display related information and/or control options to an operator. The interaction of the computer system 60 with the surface interface 50 and/or the electric field sensors 22 may be automated and/or subject to user-input.

In at least some embodiments, the computer system 60 includes a processing unit 62 that displays electric field monitoring control options and/or results by executing software or instructions obtained from a local or remote non-transitory computer-readable medium 68. The computer system 60 also may include input device(s) 66 (e.g., a keyboard, mouse, touchpad, etc.) and output device(s) 64 (e.g., a monitor, printer, etc.). Such input device(s) 66 and/or output device(s) 64 provide a user interface that enables an operator to interact with electric field monitoring components and/or software executed by the processing unit 62.

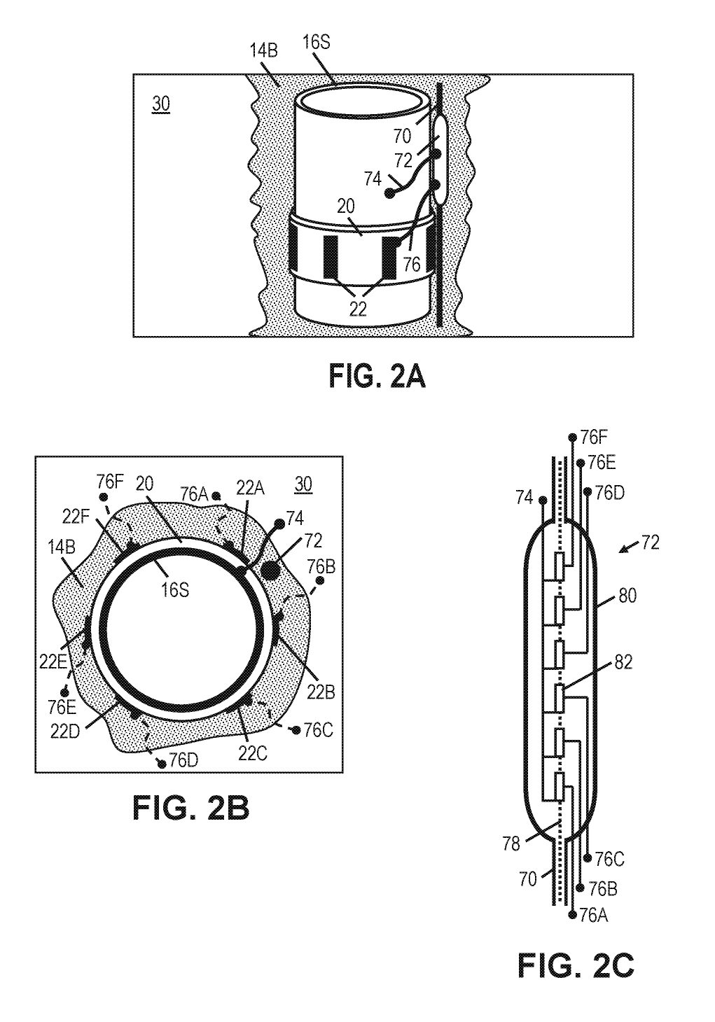

FIGS. 2A-2C are diagrams showing components of an illustrative first subsurface electric field monitoring system configuration. In FIG. 2A, a partial view of a subsurface electric field monitoring system configuration with electric field sensors 22, an insulating pad 20, and a signal transducer module 72 is represented. More specifically, the insulating pad 20 extends around an exterior circumference of the casing segment 16S and the electric field sensors 22 are mounted to the insulating pad 20 in an azimuthally-distributed arrangement. The casing segment 16S is positioned within the conductive cement section 14B to enable electric field monitoring of a target region of the downhole formation 30. The signal transducer module 72 represented in FIG. 2A couples to a fiber-optic cable 70 and operates to convert electrical signals from the electric field sensors 22 to corresponding optical signals that are conveyed to earth's surface. In at least some embodiments, the electric field sensors 22 are electrodes, where each electrode is electrically coupled to the signal transducer module 72 by an insulated conductor 76. Another insulated conductor 74 extends from the casing segment 16S to the signal transducer module 72. With the configuration shown, the signal transducer module 72 may perform phase or intensity modulation of an optical interrogation signal based on the difference between the voltage level at each electric field sensor 22 and the voltage level at the casing segment 16S. Another option would be to generate optical signals based on the difference between the voltage level at each electric field sensor 22 and the voltage level at the casing segment 16S. It should be noted that generation of optical signals downhole would necessitate a downhole power source, whereas modulating an optical interrogation signal can be accomplished without a downhole power source. Depending on the number of electric field sensors 22 and/or electric field sensor groupings (only one grouping is shown in FIG. 2A), multiplexing and de-multiplexing techniques may be employed to associate collected measurements with individual electric field sensors 22.

FIG. 2B shows a cross-sectional view of the subsurface electric field monitoring system configuration represented in FIG. 2A. In FIG. 2B, the azimuthal distribution of electric field sensors 22A-22F around the casing segment 16S and insulating pad 20 can be seen. The insulating pad 20 can be made from any electrically insulating material that can withstand downhole temperatures and pressures downhole. Example insulating materials may be used for the insulating pad 20 include ceramic, fiberglass, or epoxy resin. The thickness of the insulating pad 20 can range from 0.05″ to 0.5″, depending on criteria such as the expected clearance between the casing segment 16S and the wall of the borehole 12A, and/or a maximum acceptable capacitive coupling (shorting) between the casing segment 16S and the electric field sensors 22A-22F. In at least some embodiments, the electric field sensors 22A-22F comprise electrodes that are approximately 2″ wide and 6″ long. The size of the electrodes may be chosen to minimize the contact resistance while also having a sufficiently small azimuthal footprint so as to minimize shorting of azimuthal variations. Electric field sensor groupings may be arbitrarily spaced depending on the length of the monitoring zone and the required vertical resolution. Depending on the downhole formation 30, a typical spacing between electric field sensor groupings is around 15 to 30 ft.

In FIG. 2B, insulated conductors 76A-76F are coupled to and extend from respective electric field sensors 22A-22F. The insulated conductors 76A-76F can be connected to the signal transducer module 72. Further, an insulated conductor 74 coupled to and extending from the casing segment 16S can be connected to the signal transducer module 72. Thus, the voltage difference between each insulated conductor 76A-76F and the insulated conductor 74 corresponds to the voltage difference between each of the electric field sensors 22A-22F and the casing segment 16S.

Any electric field sensor groups, insulating pads, and connection cables, may be pre-fabricated in the form of circular or C-shaped collars that are clamped to the casing segment 16S prior to or during deployment of the casing segment. In at least some embodiments, the emitted current used for electric field monitoring operations may have a frequency that ranges from DC to 100 KHz. Lower frequencies may be used for longer transmitter/receiver spacing scenarios (for deep sensitivity), while higher frequencies are used with shorter transmitter/receiver spacing scenarios (for shallow sensitivity). In some embodiments, the current source can be used to anodize the casing to prevent or minimize corrosion.

In FIG. 2C, a cross-sectional view of the signal transducer module 72 is represented. As shown, the signal transducer module 72 includes a plurality of signal transducers 82 within a housing 80. Each signal transducer 82 is coupled to the insulated conductor 74 and one of the insulated conductors 76A-76F. In operation, each signal transducer 82 uses the voltage difference between the insulated conductor 74 and one of the insulated conductors 76A-76F to modulate an optical interrogation signal conveyed by an optical fiber 78 of the fiber-optic cable 70. Phase modulation or intensity modulation options are possible. As an example, the signal transducer 82 may comprise electro-mechanical transducers (e.g., piezoelectric materials such as lead zirconate titanate). More specifically, one terminal of the electro-mechanical transducer may be electrically connected to an electrode (i.e., an electric field sensor 22) while the other terminal of the electro-mechanical transducer is electrically connected to the casing segment 16S. The voltage difference developed between the casing segment 16S and each electrode is applied to the electro-mechanical transducer through wire connections as described herein. As the electro-mechanical transducer deforms due to the voltage difference, a strain is induced in the optical fiber 78 bonded to it. The amount of strain in the optical fiber 78 modulates a phase or intensity of an optical interrogation signal, such that the original voltage difference can be estimated by analysis of the modulated optical interrogation signal (e.g., the strain is linearly proportional to the voltage difference). By using optical signaling, electrical multiplexing circuitry downhole can be avoided. In some embodiments, the signal transducers 82 and other components of the signal transducer module 72 can be packaged in a single tubing encapsulated cable (TEC) that is clamped to the casing string 11A as the casing string 11A is being deployed. As desired, signals from multiple electric field sensor groups (at different axial locations) can be conveyed over the same fiber-optic cable 70. Signals from different electric field sensors and groups are differentiated at the surface using known fiber-optic multiplexing and decoding techniques. In a less favorable embodiment (not shown), an electronic switching circuit can be used to multiplex signals from different electrodes to an electric or fiber-optic cable that delivers the signals uphole. At earth's surface, electrical or optical signals are formatted, as needed, and are analyzed to model the subsurface electric fields. The modeled subsurface electric field is used to characterize the resistivity of the downhole formation 30, whereby waterfronts 36 can be identified and tracked as described herein.

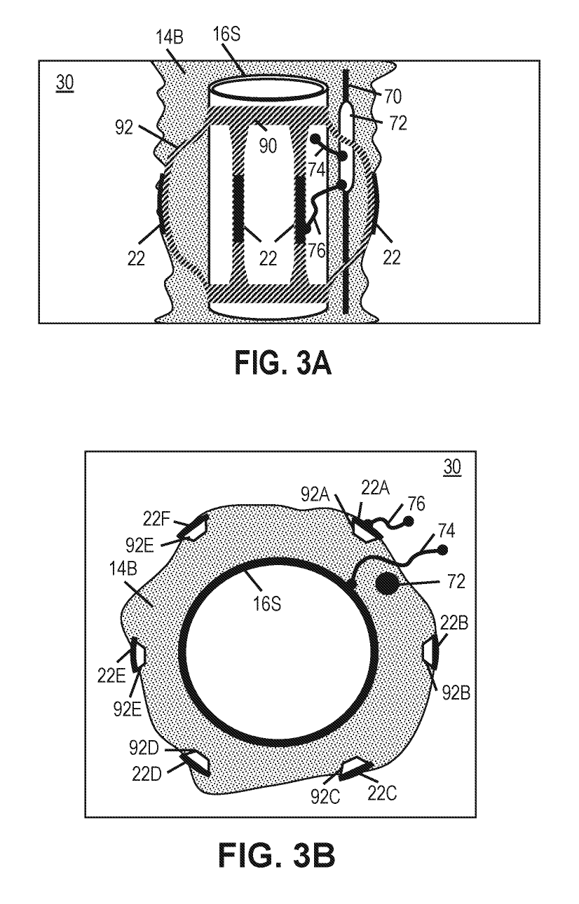

FIGS. 3A and 3B are diagrams showing components of an illustrative second subsurface electric field monitoring system configuration. Relative to the configuration of FIGS. 2A-2C, the configuration of FIGS. 3A and 3B employs an insulating centralizer 90 around the casing segment 16S instead of an insulating pad 20. The insulating centralizer 90 includes arms 92 (e.g., bow springs or other shaped members) to push the electric field sensors 22 closer to or against the downhole formation 30. In at least some embodiments, the insulated centralizer 90 is painted to insulate any conductive centralizer material (e.g., metal). In FIG. 3A, the electric field sensors 22 are mounted to the insulating centralizer 90 in an azimuthally-distributed arrangement, and the casing segment 16S is positioned within the conductive cement section 14B to enable electric field monitoring of a target region of the downhole formation 30. For FIG. 3A, the signal transducer module 72, the fiber-optic cable 70, insulated conductor 74 and 76 are again represented, and the related discussion given in FIGS. 2A and 2C applies.

FIG. 3B shows a cross-sectional view of the subsurface electric field monitoring system configuration represented in FIG. 3A. In FIG. 3B, the azimuthal distribution of electric field sensors 22A-22F around the casing segment 16S (on respective arms 92A-92F of the insulating centralizer 90) can be seen. The dimensions and/or materials of the insulating centralizer 90 may vary for different embodiments. With regarding to the electric field sensors 22 or electric field sensor groupings, the discussion given for FIGS. 2A and 2B applies. Further, the discussion of FIG. 2B and FIG. 2C with regard to the signal transducer module 72 and insulated conductors 74, 76 applies to these same components represented in FIG. 3B.

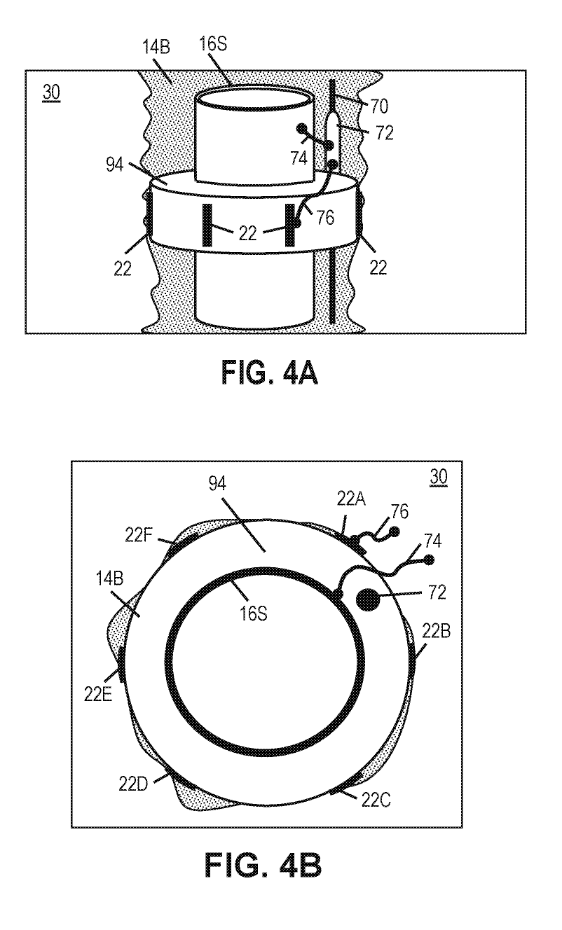

FIGS. 4A and 4B are diagrams showing components of an illustrative third subsurface electric field monitoring system configuration. The configuration of FIGS. 4A and 4B employs a swellable packer 94 around the casing segment 16S instead of an insulating pad 20 (as in FIGS. 2A and 2B) or an insulating centralizer 90 (as in FIGS. 3A and 3B). The swellable packer 94, when activated, pushes the electric field sensors 22 closer to or against the downhole formation 30. In FIG. 4A, the electric field sensors 22 are mounted to the swellable packer 94 in an azimuthally-distributed arrangement, and the casing segment 16S is positioned within the conductive cement section 14B to enable electric field monitoring of a target region of the downhole formation 30. For FIG. 4A, the signal transducer module 72, the fiber-optic cable 70, insulated conductor 74 and 76 are again represented, and the related discussion given in FIGS. 2A and 2C applies.

FIG. 4B shows a cross-sectional view of the subsurface electric field monitoring system configuration represented in FIG. 4A. In FIG. 4B, the azimuthal distribution of electric field sensors 22A-22F around the casing segment 16S and the swellable packer 94 can be seen. The dimensions and/or materials of the swellable packer 94 may vary for different embodiments. With regarding to the electric field sensors 22A-22F or electric field sensor groupings, the discussion given for FIGS. 2A and 2B applies. Further, the discussion of FIG. 2B and FIG. 2C with regard to the signal transducer module 72 and insulated conductors 74, 76 applies to these same components represented in FIG. 4B.

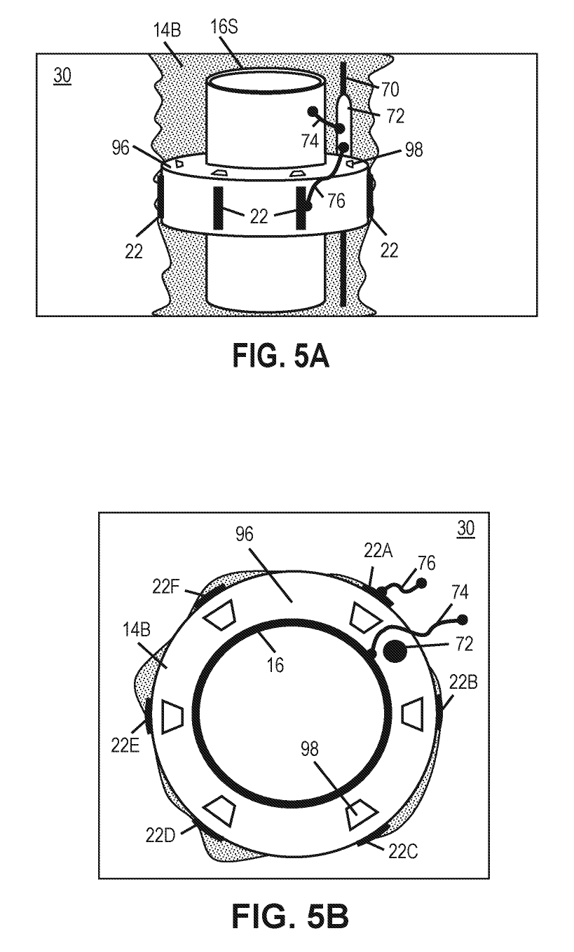

FIGS. 5A and 5B are diagrams showing components of an illustrative fourth subsurface electric field monitoring system configuration. Similar to the configuration of

FIGS. 4A and 4B, the configuration of FIGS. 5A and 5B employs a swellable packer 96 around the casing segment 16S instead of an insulating pad 20 (as in FIGS. 2A and 2B) or an insulating centralizer 90 (as in FIGS. 3A and 3B). In contrast to the swellable packer 94 of FIGS. 4A and 4B, the swellable packer 96 of FIGS. 5A and 5B includes passages 98 through which cement slurry is able to pass. Thus, the swellable packer 96 of FIGS. 5A and 5B can be activated before or during cement pumping operations (as needed, the cement slurry can pass though the passages 98). In contrast, the swellable packer 94 of FIGS. 4A and 4B would not be activated until some or all cement pumping operations are complete so as to avoid blocking cement slurry that has not reached its target location.

In FIG. 5A, the electric field sensors 22 are mounted to the swellable packer 96 in an azimuthally-distributed arrangement, and the casing segment 16S is positioned within the conductive cement section 14B to enable electric field monitoring of a target region of the downhole formation 30. For FIG. 5A, the signal transducer module 72, the fiber-optic cable 70, insulated conductor 74 and 76 are again represented, and the related discussion given in FIGS. 2A and 2C applies.

FIG. 5B shows a cross-sectional view of the subsurface electric field monitoring system configuration represented in FIG. 5A. In FIG. 5B, the azimuthal distribution of electric field sensors 22A-22F around the casing segment 16S and the swellable packer 96 can be seen. The dimensions and/or materials of the swellable packer 96 may vary for different embodiments. With regarding to the electric field sensors 22A-22F or electric field sensor groupings, the discussion given for FIGS. 2A and 2B applies. Further, the discussion of FIG. 2B and FIG. 2C with regard to the signal transducer module 72 and insulated conductors 74, 76 applies to these same components represented in FIG. 5B.

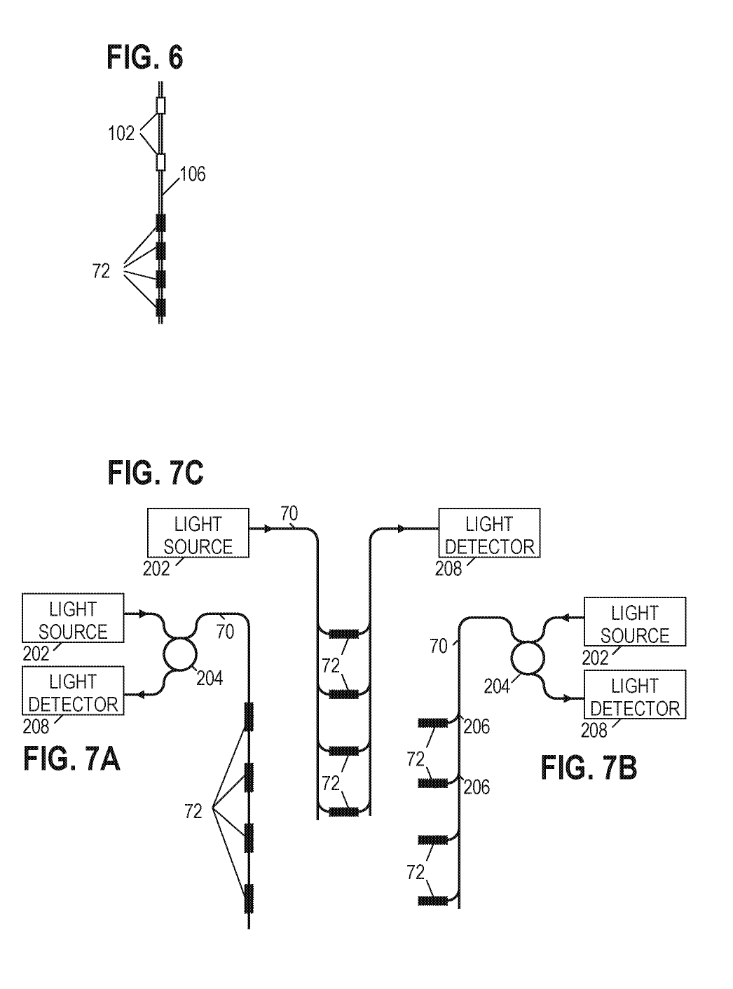

FIG. 6 is a diagram showing another electric field sensing option. In FIG. 6, an umbilical 106 with one or more electrical conductors and optical fibers is used to convey power and/or communications. For example, the umbilical 106 may be used instead of optical fiber cable 70 to convey measurements from signal transducer modules 72 to earth's surface. Further, the umbilical 106 can be used to operate electrodes or antennas for generating electromagnetic fields in addition to or instead of current injection via casing string 11A. For example, FIG. 6 shows two electrodes 102 along the umbilical 106, where a voltage generated between the two electrodes 102 creates an electric dipole radiation pattern. The response of electric field sensors 22 (not shown) to the radiated pattern can be used to derive formation parameters as described herein. In alternative embodiments, a downhole energy source (e.g., a battery) may be used to drive current to electrodes 102 and/or to the casing string 11A to establish an electric field in a target region of the downhole formation 30. As described, an energy saving scheme may be employed to turn on or off the downhole energy source periodically. Further, the output of the downhole energy source may be adjusted based on telemetry signals conveyed by the fiber-optic cable 70 or umbilical 106, or based on measurements collected by downhole sensors. Even if an umbilical 106 with one or more electrical conductors and optical fibers is available and is used to generate an electric field in the downhole formation 30, the electric field sensors 22 may operate passively (without an electrical power source). Alternatively, electric field sensor options with minimal power requirements can be powered from small batteries.

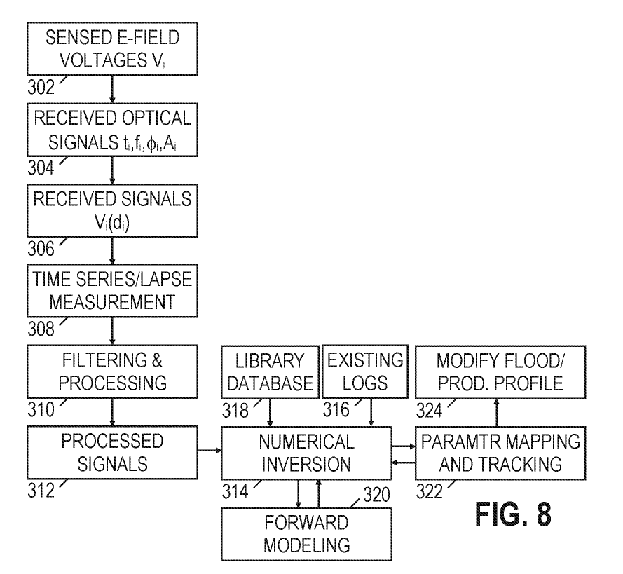

In at least some embodiments, multiple signal transducer modules 72 may be positioned along a given optical fiber. Further, time and/or frequency multiplexing may be used to separate the measurements associated with each electric field sensor 22 or signal transducer module 72. In FIG. 7A, a light source 202 emits light in a continuous beam. A circulator 204 directs the light along fiber-optic cable 70. The light travels along the cable 70, interacting with the signal transducer modules 72, before reflecting off the end of the cable and returning to circulator 204 via the signal transducer modules 72. The circulator 204 directs the reflected light to a light detector 208. The light detector 208 separates the measurements associated with the electric field sensors 22 (not shown) associated with the signal transducer modules 72 using frequency multiplexing. As an example, each sensor 22 may affect only a narrow frequency band of the light beam conveyed by the fiber-optic cable 70, where each sensor 22 is designed to affect a different frequency band.

In FIG. 7B, light source 202 emits light in short pulses. Each signal transducer module 72 is coupled to the main optical fiber via a splitter 206. The splitters direct a small fraction of the light from the optical fiber to each signal transducer module 72, e.g., 1% to 4%. The signal transducer module 72 interacts with the light and reflects it back to the detector 208 via the splitter 206, the fiber-optic cable 70, and the circulator 204. Due to the different travel distances, each pulse of light from source 202 results in a sequence of return pulses, with a first set of pulses arriving from the nearest signal transducer module 72, a second set of pulses arriving from the second nearest signal transducer module, etc. This arrangement enables the detector to separate sensor measurements on a time-multiplexed basis.

The arrangements of FIGS. 7A and 7B are both reflective arrangements in which the light reflects from a fiber termination point. They can each be converted to a transmissive arrangement in which the termination point is replaced by a return fiber that communicates the light back to the surface. FIG. 7C shows an example of such an arrangement for the configuration of FIG. 7B. A return fiber is coupled to each of the signal transducer modules sensors via a splitter to collect the light from the signal transducer modules 72 and direct it to a light detector 208.

Other arrangement variations also exist. For example, multiple signal transducer modules 72 may be coupled in series on each branch of the FIG. 7B, 7C arrangements. As desired, a combination of time-division and frequency-division multiplexing could be used to separate individual sensor measurements.

In different embodiments, production well or monitoring well 8A may be equipped with a permanent array of electric field sensors 22 distributed along axial, azimuthal and radial directions outside the casing string 11A. The electric field sensors 22 may be positioned inside cement of the conducting cement section 14B or at the boundary between the cement and the downhole formation 30. Each electric field sensor 22 is either on or in the vicinity of a fiber-optic cable 70 that serves as the communication link with earth's surface. Signal transducer modules 72 can directly interact with the fiber-optic cables 70 or, in some contemplated embodiments, may produce electrical signals that in turn induce thermal, mechanical (strain), acoustic or electromagnetic effects on an optical fiber. Each fiber-optic cable 70 may be associated with multiple electric field sensors 22, and each electric field sensor 22 may produce a signal in multiple fiber-optic cables. The electric field sensor 22 can be positioned based on a predetermined pattern, geology consideration, or made randomly. In any configuration, the sensor positions can often be precisely located by analysis of light signal travel times.

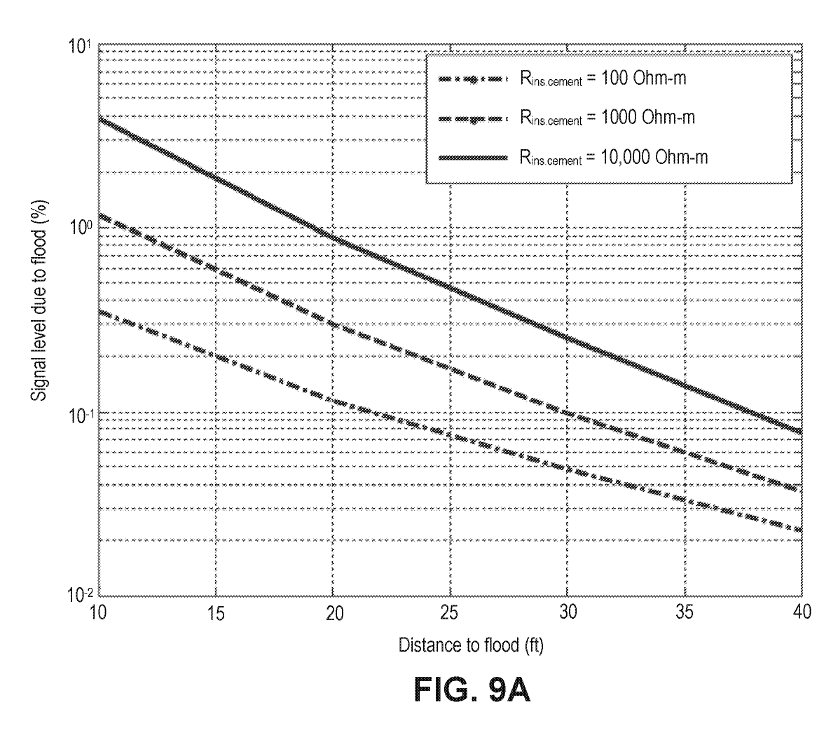

FIG. 8 is a signal flow diagram for an illustrative formation monitoring method. In different embodiments, a fixed (DC) electric field or alternating current (AC) electric field is generated by emitting current into a target portion of a downhole formation 30 as described herein. Example AC electric fields may have a frequency in the range of 0.1 Hz to 100 kHz. In response to generating a DC or AC electric field in the downhole formation 30, electric field voltages (Vᵢ, where i is the sensor number) are sensed at block 302 by electric field sensors 22.

In block 304, the voltages are applied to modify some characteristic of light passing through an optical fiber, e.g., travel time, frequency, phase, amplitude. In block 306, the surface receiver extracts the represented voltage measurements and associates them with a sensor position dᵢ. The measurements are repeated and collected as a function of time in block 308. In block 310, a data processing system filters and processes the measurements to calibrate them and improve signal to noise ratio. Suitable operations include filtering in time to reduce noise; averaging multiple sensor data to reduce noise; taking the difference or the ratio of multiple voltages to remove unwanted effects such as a common voltage drift due to temperature; other temperature correction schemes such as a temperature correction table; calibration to known/expected resistivity values from an existing well log; and array processing (software focusing) of the data to achieve different depth of detection or vertical resolution.

In block 312, the processed signals are stored for use as inputs to a numerical inversion process in block 314. Other inputs to the inversion process are existing logs (block 316) such as formation resistivity logs, porosity logs, etc., and a library of calculated signals 318 or a forward model 320 of the system that generates predicted signals in response to model parameters, e.g., a two- or three-dimensional distribution of resistivity. As part of generating the predicted signals, the forward model determines a multidimensional model of the subsurface electric field. All resistivity, electric permittivity (dielectric constant) or magnetic permeability properties of the formation can be measured and modeled as a function of time and frequency. The parameterized model can involve isotropic or anisotropic electrical (resistivity, dielectric, permeability) properties. More complex models can be employed so long as sufficient numbers of sensor types, positions, orientations, and frequencies are employed. The inversion process searches a model parameter space to find the best match between measured signals 312 and generated signals. In at least some embodiments, the best match may be based on a cost function that is defined as a weighted sum of a power of absolute differences between measured signals 312 and generated signals. For example, an L1-norm (power of 1) or L2-norm (power of 2) may be employed. In block 322 the parameters are stored and used as a starting point for iterations at subsequent times.

While the current focusing techniques disclosed herein should extend the range of electric field sensitivity and reduce the effects of tubing, casing, mud and cement on measurement analysis, such effects can be corrected using a-priori information on these parameters, or by solving for some or all of them during the inversion process. Since all of these effects are mainly additive and they remain the same in time, a time-lapse measurement can remove them. Multiplicative (scaling) portion of the effects can be removed in the process of calibration to an existing log. All additive, multiplicative and any other non-linear effect can be solved for by including them in the inversion process as a parameter.

The motion of reservoir fluid interfaces can be derived from the parameters and used as the basis for modifying the production profile in block 324. Production from a well is a dynamic process and each production zone's characteristics may change over time. For example, in the case of water flood injection from a second well, water front may reach some of the perforations and replace the existing oil production. Since flow of water in formations is not very predictable, stopping the flow before such a breakthrough event requires frequent monitoring of the formations.

Profile parameters such as flow rate/pressure in selected production zones, flow rate/pressure in selected injection zones, and the composition of the injection fluid, can each be varied. For example, injection from a secondary well can be stopped or slowed down when an approaching water flood is detected near the production well. In the production well, production from a set of perforations that produce water or that are predicted to produce water in relatively short time can be stopped or slowed down.

We note here that the time lapse signal derived from the measured electric field is expected to be proportional to the contrast between formation parameters. Hence, it is possible to enhance the signal created by an approaching flood front by enhancing the electromagnetic contrast of the flood fluid relative to the connate fluid. For example, a high electrical permittivity or conductivity fluid can be used in the injection process in the place of or in conjunction with water. It is also possible to achieve a similar effect by injecting a contrast fluid from the wellbore in which monitoring is taking place, but this time changing the initial condition of the formation.

The disclosed methods and systems may be employed for periodic or continuous time-lapse monitoring of formations including a water flood volume. They may further enable optimization of hydrocarbon production by enabling the operator to track flows associated with each perforation and selectively block water influxes. Precise localization of the sensors is not required during placement since that information can be derived afterwards via the fiber-optic cable. Casing source embodiments do not require separate downhole EM sources, significantly decreasing the system cost and increasing reliability.

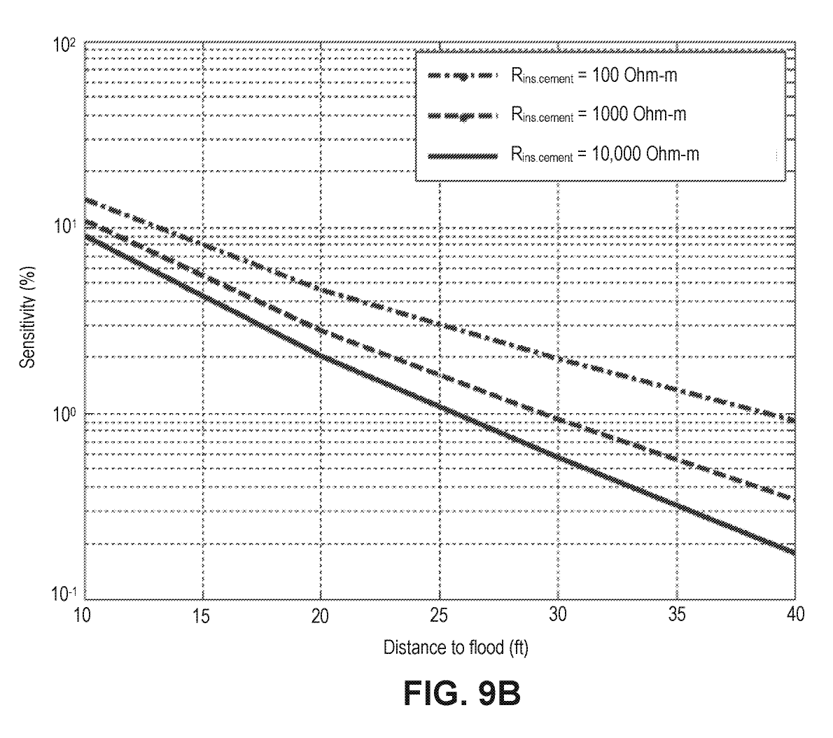

FIG. 9A is a graph showing illustrative signal levels for different insulating cement resistivities, while FIG. 9B is a graph showing illustrative sensitivity for different insulating cement resistivities. More specifically, FIG. 9A shows the signal level due to flood as a function of distance to flood for different insulating cement resistivities. Meanwhile, FIG. 9B shows the sensitivity as a function of distance to flood for different insulating cement resistivities. The results of FIGS. 9A and 9B are based on a model with a multi-layer cement arrangement having a conducting cement section (e.g., section 14A) and non-conductive cement sections (e.g., sections 14A and 14C). Such non-conductive cement sections may have different insulting cement resistivities as represented in FIGS. 9A and 9B. Further, the model assumes a casing string with a length of 100 m casing and an outer diameter of 7″ is cemented in a 9″ borehole. The reservoir is assumed to be 50 feet thick with a resistivity of 100 Ω m. Adjacent shale layers have a resistivity of 5 Ω m. Further, the waterflood is 10 feet thick, centered in the reservoir, and has resistivity of 20 Ω m. Further, a current of 1 Amp is injected through the casing. Further, measurement electrodes are located at the center of the reservoir and are spaced from the casing by 0.5″. Further, cement in the production zone has the same resistivity as the formation (100 Ω m). As the flood approaches, measured signal levels due to flood are plotted in FIG. 9A for different insulating cement resistivities. Insulating cement with 100 Ω m resistivity corresponds to the case of non-layered (uniform) cement throughout the well. Using insulating cement with higher resistivity outside the production zone increases the signal level; for example, cement with 100 times higher resistivity increases the signal level by a factor of 5 on average.

It is to be noted, however, that using higher resistivity cement outside the production zone decreases the sensitivity (see FIG. 9B), where sensitivity is defined as the ratio between the signal due to flood and the total signal. Lower sensitivity requires sensors with higher dynamic range to resolve the signal level due to flood. As desired, differential measurements can be made to improve the dynamic range in this case.

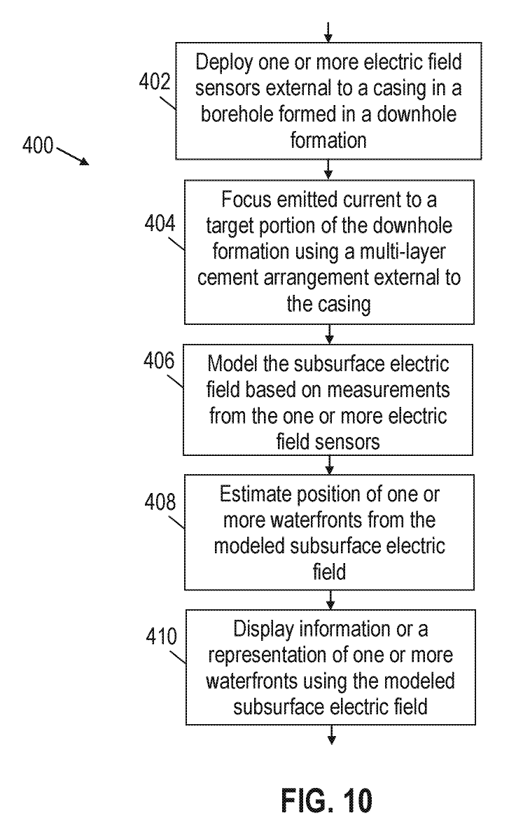

FIG. 10 is a flowchart showing an illustrative subsurface electric field monitoring method 400 involving a current focusing cement arrangement. At block 402 of method 400, one or more electric field sensors (e.g., electric field sensors 22) are deployed external to a casing (e.g., casing segment 16S) in a borehole formed in a downhole formation. At block 404, an emitted current is focused to a target portion of the downhole formation using a multi-layer cement arrangement (e.g., arrangement 9) external to the casing. At block 406, the subsurface electric field resulting from the focused current is modeled based on measurements from the one or more electric field sensors. At block 408, the position of one or more waterfronts is estimated from the modeled subsurface electric field. At block 410, display information or a representation of the one or more waterfronts using the modeled subsurface electric field. As an example, the modeled subsurface electric field can be used to assign an electromagnetic property values (e.g., resistivity or conductivity) through the target region of the downhole formation. From the assigned electromagnetic property values, the position of any waterfronts can be identified. The position of the waterfronts can be displayed or represented on a computer display (e.g., of computer 60). The identified position of waterfronts can be used to control production or injection operations. The control of such operations can be automated or based on user-input.

Embodiments disclosed herein include:

A: A subsurface electric field monitoring system that comprises one or more electric field sensors deployed external to a casing in a borehole formed in a downhole formation. The system also comprises a multi-section cement arrangement external to the casing, wherein the multi-layer cement arrangement focuses emitted current to a target region of the downhole formation. The system also comprises a data processing system that receives measurements collected by the one or more electric field sensors in response to the focused emitted current, wherein the data processing system models the subsurface electric field based on the received measurements.

B: A subsurface electric field monitoring method that comprises deploying one or more electric field sensors external to a casing in a borehole formed in a downhole formation. The method also comprises focusing emitted current to a target region of the downhole formation using a multi-section cement arrangement external to the casing. The method also comprises receiving measurements collected by the one or more electric field sensors in response to said focusing. The method also comprises modeling the subsurface electric field based on the received measurements.

Each of the embodiments, A and B, may have one or more of the following additional elements in any combination. Element 1: further comprising a display coupled to the data processing system, wherein the data processing system estimates position of one or more waterfronts in the downhole formation using the modeled subsurface electric field and wherein the display presents position information or a representation of the estimated one or more waterfronts to a user. Element 2: further comprising at least one optical fiber to optically convey measurements collected by the one or more electric field sensors to a surface interface. Element 3: further comprising a signal transducer module coupled to the one or more electric field sensors and the optical fiber, wherein the signal transducer module converts electrical signal measurements from each of one or more electric field sensors to corresponding optical signals. Element 4: wherein the one or more electric field sensors correspond to an array configured to collect a plurality of azimuthally-sensitive electrical field measurements in response to the to the focused emitted current. Element 5: wherein the multi-layer cement arrangement comprises a conductive layer of cement between two non-conductive layers of cement. Element 6: wherein the conductive layer of cement comprises a carbon additive. Element 7: wherein the non-conductive layers of cement comprise a ceramic powder, epoxy resin, or polyester resin additive. Element 8: wherein each of the one or more electric field sensors comprises an electrode mounted on an insulated pad exterior to the casing. Element 9: wherein each of the one or more electric field sensors comprises an electrode mounted on a swellable packer or insulated centralizer exterior to the casing. Element 10: wherein the swellable packer includes one or passages that allow cement slurry associated with the multi-layer cement arrangement to pass through.

Element 11: further comprising estimating position of one or more waterfronts in the downhole formation using the modeled subsurface electric field, and displaying information or a representation of the estimated one or more waterfronts. Element 12: further comprising converting electrical signal measurements from each of the one or more electric field sensors to corresponding optical signals, and conveying the optical signals to a surface interface via an optical fiber. Element 13: further comprising collecting a plurality of azimuthally-sensitive electrical field measurements in response to the focused emitted current. Element 14: further comprising deploying the multi-layer cement arrangement as a conductive layer of cement between two non-conductive layers of cement. Element 15: further comprising mounting the one or more electric field sensors on an insulated pad exterior to a casing segment prior to said deploying. Element 16: further comprising mounting the one or more electric field sensors on an insulated centralizer exterior to the casing segment prior to said deploying. Element 17: further comprising mounting the one or more electric field sensors on a swellable packer exterior to a casing segment prior to said deploying. Element 18: further comprising pumping cement slurry corresponding to at least part of multi-layer cement arrangement through one or passages in the swellable packer.

Numerous other variations and modifications will become apparent to those skilled in the art once the above disclosure is fully appreciated. For example, the disclosed sensing configurations can be used in a cross-well tomography scenario, where current is emitted and focused from one well, while electric field sensors are positioned along and collect measurements from one or more other wells. It is intended that the following claims be interpreted to embrace all such variations and modifications where applicable.

1. A subsurface electric field monitoring system that comprises:
one or more electric field sensors deployed external to a casing in a borehole formed in a downhole formation;
a multi-layer cement arrangement external to the casing, wherein the multi-layer cement arrangement focuses emitted current to a target region of the downhole formation; and
a data processing system that receives measurements collected by the one or more electric field sensors in response to the focused emitted current, wherein the data processing system models the subsurface electric field based on the received measurements.

2. The system of claim 1, further comprising a display coupled to the data processing system, wherein the data processing system estimates position of one or more waterfronts in the downhole formation using the modeled subsurface electric field and wherein the display presents position information or a representation of the estimated one or more waterfronts to a user.

3. The system of claim 1, further comprising at least one optical fiber to optically convey measurements collected by the one or more electric field sensors to a surface interface.

4. The system of claim 3, further comprising a signal transducer module coupled to the one or more electric field sensors and the optical fiber, wherein the signal transducer module converts electrical signal measurements from each of one or more electric field sensors to corresponding optical signals.

5. The system of claim 1, wherein the one or more electric field sensors correspond to an array configured to collect a plurality of azimuthally-sensitive electrical field measurements in response to the to the focused emitted current.

6. The system of claim 1, wherein the multi-layer cement arrangement comprises a conductive layer of cement between two non-conductive layers of cement.

7. The system of claim 6, wherein the conductive layer of cement comprises a carbon additive.

8. The system of claim 6, wherein the non-conductive layers of cement comprise at least one of a ceramic powder, epoxy resin, and polyester resin additive.

9. The system according to claim 1, wherein each of the one or more electric field sensors comprises an electrode mounted on an insulated pad exterior to the casing.

10. The system according to claim 1, wherein each of the one or more electric field sensors comprises an electrode mounted on a swellable packer or insulated centralizer exterior to the casing.

11. The system of claim 10, wherein the swellable packer includes at least one passage that allows cement slurry associated with the multi-layer cement arrangement to pass through.

12. A subsurface electric field monitoring method that comprises:
deploying one or more electric field sensors external to a casing in a borehole formed in a downhole formation; focusing emitted current to a target region of the downhole formation using a multi-layer cement arrangement external to the casing; and
receiving measurements collected by the one or more electric field sensors in response to said focusing; and
modeling the subsurface electric field based on the received measurements.

13. The method of claim 12, further comprising:
estimating position of one or more waterfronts in the downhole formation using the modeled subsurface electric field; and
displaying information or a representation of the estimated position of the one or more waterfronts.

14. The method of claim 12, further comprising:
converting electrical signal measurements from each of the one or more electric field sensors to corresponding optical signals; and
conveying the corresponding optical signals to a surface interface via an optical fiber.

15. The method of claim 12, further comprising collecting a plurality of azimuthally-sensitive electrical field measurements in response to the focused emitted current.

16. The method of claim 12, further comprising deploying the multi-layer cement arrangement as a conductive layer of cement between two non-conductive layers of cement.

17. The method according to claim 12, further comprising mounting the one or more electric field sensors on an insulated pad exterior to a casing segment prior to said deploying.

18. The method according to claim 12, further comprising mounting the one or more electric field sensors on an insulated centralizer exterior to a casing segment prior to said deploying.

19. The method according to claim 12, further comprising mounting the one or more electric field sensors on a swellable packer exterior to a casing segment prior to said deploying.

20. The method of claim 19, further comprising pumping cement slurry corresponding to at least part of the multi-layer cement arrangement through one or passages in the swellable packer.
